(19) United States
(12) Patent Application Publication
(10) Pub. No.: US 2003/0224830 A1
(43) Pub. Date: Dec. 4, 2003

(54) Mobile telephone capable of displaying image of caller automatically and method for realize it

(76) Inventors: Zhi-Yun Zhang, Shanghai (CN); Shih-Kuang Tsai, Shanghai (CN)

Correspondence Address: BIRCH STEWART KOLASCH & BIRCH, PO BOX 747, FALLS CHURCH, VA, 22040-0747, US

(21) Appl. No.: 10/156,815

(22) Filed: May 30, 2002

(51) Int. Cl. H04M 1/00

(52) U.S. Cl. 455/566; 455/415

(57) ABSTRACT

A mobile telephone capable of displaying an image of a caller automatically. The mobile telephone includes an input device, a storage media, a caller register, a query device and a display device. While receiving a call, the mobile telephone displays an image of a caller. The invention also provides a method for automatically displaying an image of a caller in a mobile telephone. After receiving an incoming telephone number, the mobile telephone seeks the incoming telephone number in a predetermined look-up table that comprises telephone numbers and images corresponding to the incoming telephone numbers. Lastly, when finding the incoming telephone number in the look-up table, the image corresponding to the incoming telephone number is displayed on the display device of the mobile telephone.

### BACKGROUND OF THE INVENTION

1. Field of the Invention

The present invention relates to a mobile telephone, and particularly to a mobile telephone that is capable of automatically displaying an image of a caller and a method for automatically displaying am image of a caller in a mobile telephone.

2. Description of the Related Art

With the progress of telecommunication technology, mobile telephones have become popular personal communication products. Mobile telephones are not only machines for personal communication but also products with humanity. When designing mobile telephones, we need to consider users' feeling and satisfy users' demand.

Nowadays, most mobile telephones provide caller identification. With a mobile telephone capable of recognizing the caller identification code (hereinafter referred as a CID mobile telephone), the telephone number of the calling party can be recongnized. Then, a LCD provided on the CID mobile telephone with simple user interface can display the telephone number. The CID mobile telephone also can display different words or colors that represent different callers on the LCD. Thus, when the mobile telephone receives the incoming call, the user can determine whether or not to answer the phone according to the information displayed on the mobile telephone. It is possible to save hundreds sets of information, each of which corresponds to a caller in the telephone directory of the mobile telephone. A set of information may include telephone number, name and displaying color. However, it is not easy for people to remember so much corresponding information. Although a user can get information about an incoming call according to a LCD provided on a CID mobile telephone, the user still does not know the person represented by the information. For example, a user of a mobile telephone gets a call made by a good friend who has not contacted the user for a long time. The information showing on the LCD may be a nickname that the user does not remember. This is not helpful for the user to determine whether or not to answer the phone. The user may think the caller is an unfamiliar person and determine not to answer the phone, when in fact, if the user misses the call, the user will be upset.

### SUMMARY OF THE INVENTION

Accordingly, to address the drawbacks of a conventional CID mobile telephone, an object of the present invention is to provide a mobile telephone capable of displaying an image of a caller automatically when the mobile telephone receives a call.

The present invention provides a mobile telephone capable of displaying an image of a caller automatically that comprises an input device, a storage media, a caller register, a query device and a display device. The input device comprises a telephone number input device for receiving telephone numbers and an image input device for receiving images corresponding to the telephone numbers. A look-up table which comprises the telephone numbers, wherein each image corresponds to one of telephone numbers and index numbers, is stored in the storage media. An incoming telephone number is stored in the caller register. In the query device, the incoming telephone number and the telephone numbers are compared one by one to find incoming telephone number in the look-up table. The image corresponding to the incoming telephone number is displayed on a display device.

Furthermore, the invention also provides a method for automatically displaying an image of a caller in a mobile telephone. First, at least one input method is used to obtain at least one telephone number and at least one image, wherein each image separately corresponds to one of the telephone numbers. The input methods comprise downloading the images from a digital camera, downloading the images from an image storage media, downloading the telephone numbers from a telephone number storage media and inputting the telephone numbers from a user interface. Then, a look-up table that comprises the telephone numbers and the images corresponding to the telephone numbers is established. The step of establishing the look-up table comprises the sub-steps of: establishing at least one index number, each of which separately corresponds to one of the telephone numbers; and storing the images corresponding to the telephone numbers. Next, an incoming telephone number is received. The incoming telephone number and the telephone numbers of the look-up table are compared one by one to find the incoming telephone number in the look-up table. Lastly, when the incoming telephone number is found in the look-up table, the image corresponding to the incoming telephone number is displayed. When the incoming telephone number is not found in the look-up table, the incoming telephone number is displayed.

### BRIEF DESCRIPTION OF THE DRAWINGS

The present invention can be more fully understood by reading the subsequent detailed description in conjunction with the examples and references made to the accompanying drawings, wherein:

FIG. 1 is a block diagram illustrating a mobile telephone capable of displaying an image of a caller automatically in the embodiment of the present invention;

FIG. 2 is a block diagram illustrating the input device in the embodiment of the present invention;

FIG. 3 is a flowchart illustrating the method for automatically displaying an image of a caller in a mobile telephone according to the embodiment of the present invention;

FIG. 4 is a flowchart illustrating the method for establishing a look-up table according to the embodiment of the present invention; and

FIG. 5 is a schematic diagram illustrating an example of the look-up table in the embodiment of the present invention.

### DETAILED DESCRIPTION OF THE PREFERRED EMBODIMENT

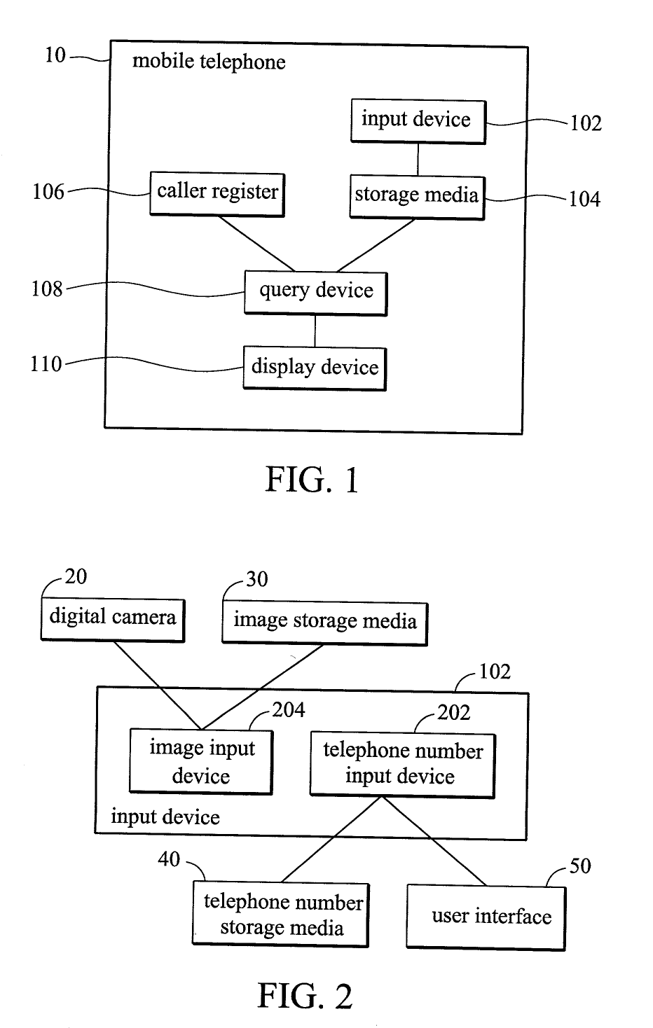

FIG. 1 is a block diagram illustrating a mobile telephone capable of displaying an image of a caller automatically in the embodiment of the present invention. Referring to FIG. 2, the mobile telephone 10 comprises an input device 102, a storage media 104, a caller register 106, a query device 108 and display device 110. The input device 102 receives at least one telephone number and at least one image, each of which separately corresponds to each of the telephone numbers. The images corresponding to the telephone numbers could be graphs or photographs. The input device 102 will become more apparent by referring to the following description with reference to the FIG. 2. A look-up table is stored in the storage media 104. The look-up table comprises the telephone numbers and the images corresponding to the telephone numbers. The look-up table further comprises index numbers, each of which separately corresponds to each of the telephone numbers. An incoming telephone number is stored in the caller register 106. In the query device 108, the incoming telephone number and the telephone numbers stored in the look-up table of the storage media 104 are compared one by one. When the incoming telephone number is found in the look-up table of the storage media 104, the image corresponding to the incoming telephone number is displayed on the display device 110. When the incoming telephone number is not found in the look-up table of the storage media 104, the incoming telephone number is displayed on the display device 110.

FIG. 2 is a block diagram illustrating the input device in the embodiment of the present invention. As shown in FIG. 2, the input device 102 comprises a telephone number input device 202 for receiving telephone numbers and an image input device 204 for receiving images corresponding to the telephone numbers. Those telephone numbers and images are stored in the look-up table of the storage media 104. In FIG. 2, there is a digital camera 20, an image storage media 30, a telephone number storage media 40 and a user interface 50. The images corresponding to the telephone numbers could be graphs or photographs. The user of the mobile telephone draws graphs on the image input device 204. The image input device 204 is a LCD provided on the CID mobile telephone (not shown in FIG. 2). The photographs can be downloaded from the digital camera 20 or the image storage media 30 to the image input device 204. Each of images separately corresponds to one of the telephone numbers. The telephone numbers can be downloaded from the telephone number storage media 40 to the telephone number input device 202. The telephone numbers can also be input from the user interface 50 to the telephone number input device 202. All telephone numbers and images received are stored in the look-up table of the storage media 104.

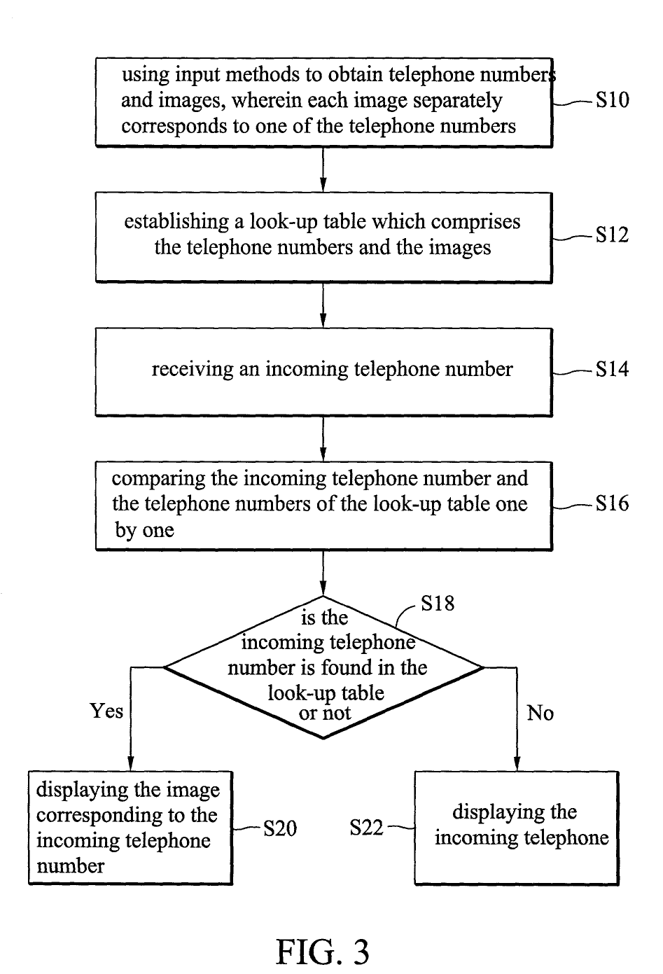

FIG. 3 is a flowchart illustrating the method for automatically displaying an image of a caller in a mobile telephone according to the embodiment of the present invention. First, at least one input method is used to obtain at least one telephone number and at least one image, wherein each image separately corresponds to one of the telephone numbers (S10) The images corresponding to the telephone numbers may be graphs or photographs. In conjunction with the input device shown in FIG. 2, the input methods comprises downloading the images from the digital camera, downloading the images from the image storage media, downloading the telephone numbers from the telephone number storage media and inputting the telephone numbers from the user interface.

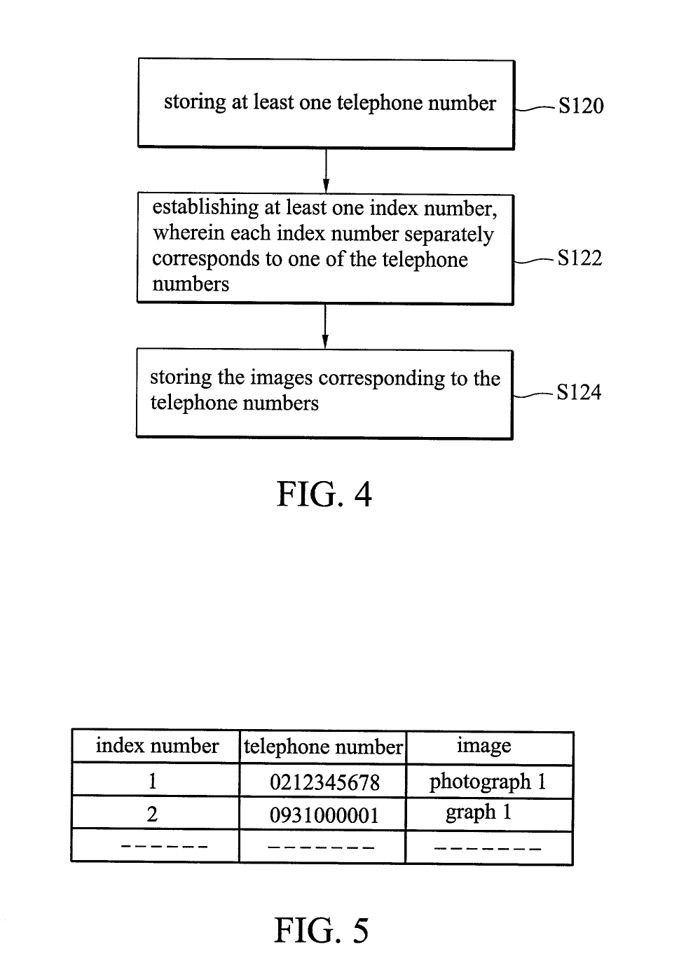

Then, a look-up table that comprises the telephone numbers and the images corresponding to the telephone numbers is established (s12). The flowchart illustrating the method for establishing the look-up table will be described in the following passage (see FIG. 4). Next, an incoming telephone number is received (S14). The incoming telephone number and the telephone numbers of the look-up table are compared one by one to find the incoming telephone number in the look-up table (S14). Then, according to the compared result, it is determined whether the incoming telephone number is found in the look-up table or not (s18). Lastly, when the incoming telephone number is found in the look-up table, the image corresponding to the incoming telephone number is displayed (s20). When the incoming telephone number is not found in the look-up table, the incoming telephone number is displayed (s22).

FIG. 4 is a flowchart illustrating the method for establishing a look-up table according to the embodiment of the present invention. First, at least one telephone numbers are is stored into look-up table (S120). Then, at least one index number is established (S122). Each index number separately corresponds to one of the telephone numbers. The index number is used to compare the incoming telephone number and the telephone numbers of the look-up table one by one (see to S16 in FIG. 3). Finally, the images corresponding to the telephone numbers are stored into look-up table (s124).

FIG. 5 is a schematic diagram illustrating an example of the look-up table in the embodiment of the present invention. As shown in FIG. 5, there are three columns in the look-up table. They are index numbers, telephone numbers and images. Each of the index numbers separately corresponds to one of the telephone numbers and one of the images. As described above, the look-up table is stored in the storage media 104 and is used in the query device 108. By using the index numbers, the incoming telephone number and the telephone numbers stored in the look-up table are compared one by one in the query device 108.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A mobile telephone capable of displaying an image of a caller automatically, comprising:
an input device for receiving at least one telephone number and at least one image, wherein each image separately corresponds to one of the telephone numbers;
a storage media for storing a look-up table which comprises the telephone numbers and the images corresponding to the telephone numbers;
a caller register for storing an incoming telephone number;
a query device for comparing the incoming telephone number and the telephone numbers one by one and finding the incoming telephone number in the look-up table; and
a display device for displaying the image corresponding to the incoming telephone number.

2. The mobile telephone as claimed in claim 1, wherein the input device comprises:
a telephone number input device for receiving the telephone numbers; and
an image input device for receiving the images corresponding to the telephone numbers.

3. The mobile telephone as claimed in claim 1, wherein the look-up table comprises:
at least one index number, each of which separately corresponds to one of the telephone numbers, for use by the query device to compare the incoming telephone number and the telephone numbers one by one.

4. The mobile telephone as claimed in claim 1, wherein the images corresponding to the telephone numbers are graphs.

5. The mobile telephone as claimed in claim 1, wherein the images corresponding to the telephone numbers are photographs.

6. The mobile telephone as claimed in claim 5, wherein the photographs are downloaded from an image input device to the input device.

7. The mobile telephone as claimed in claim 5, wherein the photographs are downloaded from an image storage media to the input device.

8. The mobile telephone as claimed in claim 1, wherein the telephone numbers are downloaded from a telephone number storage media to the input device.

9. The mobile telephone as claimed in claim 1, wherein the telephone numbers are input from a user interface to the input device.

10. A method for automatically displaying an image of a caller in a mobile telephone, the method comprising the steps of:
using input methods to obtain at least one telephone number and at least one image, wherein each image corresponds to one of the telephone numbers;
establishing a look-up table which comprises the telephone numbers and the images corresponding to the telephone numbers;
receiving an incoming telephone number;
comparing the incoming telephone number and the telephone numbers of the look-up table one by one to find the incoming telephone number in the look-up table; and
displaying the image corresponding to the incoming telephone number when finding the incoming telephone number in the look-up table.

11. The method as claimed in claim 10 further comprising the step of:
displaying the incoming telephone number when not finding the incoming telephone number in the look-up table.

12. The method as claimed in claim 10, wherein in the step of establishing the look-up table comprises the sub-steps of:
storing at least one telephone number;
establishing at least one index number, each of which separately corresponds to one of the telephone numbers; and
storing the images corresponding to the telephone numbers.

13. The method as claimed in claim 10, wherein the images corresponding to the telephone numbers are graphs.

14. The method as claimed in claim 10, wherein the images corresponding to the telephone numbers are photographs.

15. The method as claimed in claim 10, wherein the input method for the images is to download the images from a digital camera.

16. The method as claimed in claim 10, wherein the input method for the images is to download the images from an image storage media.

17. The method as claimed in claim 10, wherein the input method for the telephone numbers is to download the telephone numbers from a telephone number storage media.

18. The method as claimed in claim 10, wherein the input method for the telephone numbers is to input the telephone numbers from a user interface.
